(19) United States
(12) Patent Application Publication
(10) Pub. No.: US 2026/0148526 A1
(43) Pub. Date: May 28, 2026

(54) METHOD AND SYSTEM FOR PROCESSING AN IMAGE

(71) Applicants: The Hong Kong University of Science and Technology, Hong Kong (CN); AI Chip Center for Emerging Smart Systems Limited, Hong Kong (CN)

(72) Inventors: Pingcheng DONG, Shaoguan (CN); Yonghao TAN, Hong Kong (CN); Xuejiao LIU, Shenzhen (CN); Yu LIU, Hong Kong (CN); Peng LUO, Shenzhen (CN); Luhong LIANG, Hong Kong (CN); Fengbin TU, Hong Kong (CN); Kwang Ting CHENG, Hong Kong (CN)

(21) Appl. No.: 19/342,808

(22) Filed: Sep. 29, 2025

Related U.S. Application Data
(60) Provisional application No. 63/724,422, filed on Nov. 25, 2024.

(51) Int. Cl. G06V 10/77; G06V 10/82; G06V 10/94

(52) U.S. Cl. CPC G06V 10/7715; G06V 10/82; G06V 10/955

(57) ABSTRACT

A method for processing an image, comprising: generating, by a hybrid attention processing unit, a first matrix based on a feature associated with the image and a second matrix based on information associated with the feature; and processing, by the hybrid attention processing unit, the image with the first and second matrices based on a linear attention process.

### CROSS-REFERENCE TO RELATED APPLICATIONS

This application claims priority to the U.S. provisional patent application Ser. No. 63/724,422, filed Nov. 25, 2024, hereby incorporated herein by reference as to its entirety.

### FIELD

The present disclosure relates generally to a method and system for processing an image.

### BACKGROUND

Hybrid models integrating convolutional neural network (CNN) and Transformer (e.g., a ConvFormer) have achieved significant advancements in semantic segmentation tasks, which are critical for autonomous driving and embodied intelligence.

However, while CNN enhances the multi-scale feature extraction ability of the transformer to achieve pixel-level classification, the large token length (TL) demand of semantic segmentation (>16K TL) incurs significant computation and memory overheads. Moreover, performance bottlenecks of ConvFormers exist in the memory-intensive Backbone and compute-intensive Segmentation Head (Seg. Head).

New methods and systems that assist in advancing technological needs and industrial applications in this area are desirable.

### SUMMARY

A method comprises: generating, by a hybrid attention processing unit, a first matrix based on a feature associated with the image and a second matrix based on information associated with the feature; and processing, by the hybrid attention processing unit, the image with the first and second matrices based on a linear attention process.

Other embodiments will be described herein.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the disclosure will be better understood and readily apparent to one of ordinary skill in the art from the following written description, by way of example only, and in conjunction with the drawings, in which:

FIG. 1 shows an exemplary overview of a hybrid convolutional neural network (CNN) transformer (ConvFormer) model of the state of the art.

FIG. 2 shows an exemplary illustration of issues faced by a hybrid ConvFormer model of the state of the art.

FIG. 3 shows an exemplary illustration of a further issue faced by a hybrid ConvFormer model of the state of the art.

FIG. 4 shows an overall architecture of a proposed ConvFormer accelerator according to certain embodiments of the present disclosure.

FIG. 5 shows an exemplary hybrid-attention processing mechanism and its hardware implementation according to certain embodiments of the present disclosure.

FIG. 6 shows an exemplary workflow of a layer-fusion scheduler (LFS) according to certain embodiments of the present disclosure.

FIG. 7 shows an exemplary illustration of the LFS in further detail according to certain embodiments of the present disclosure.

FIG. 8 shows an exemplary workflow of a cascaded feature map pruner (CFMP) for sparsity optimization according to certain embodiments of the present disclosure.

FIG. 9 shows an exemplary illustration of the CFMP in further detail according to certain embodiments of the present disclosure.

FIG. 10 shows an exemplary illustration of a CFMP pipeline chart according to certain embodiments of the present disclosure.

FIG. 11 shows a table for evaluation on typical ConvFormer models according to certain embodiments of the present disclosure.

FIG. 12 shows an exemplary illustration for an improvement breakdown analysis on a ConvFormer model SegFormer-B0 according to certain embodiments of the present disclosure.

FIG. 13 shows a table for comparison with state-of-the-art accelerators according to certain embodiments of the present disclosure.

FIG. 14 shows a schematic diagram of an exemplary computing device suitable for use in processing an image according to certain embodiments of the present disclosure.

### DETAILED DESCRIPTION

Embodiments of the present disclosure will be described, by way of example only, with reference to the drawings. Like reference numbers and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “detecting”, “estimating”, “comparing”, “receiving”, “calculating”, “determining”, “updating”, “generating”, “initializing”, “outputting”, “receiving”, “retrieving”, “identifying”, “dispersing”, “authenticating”, “decomposing” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

### Exemplary Embodiments

Various embodiments of the present disclosure relate to a method and system for processing an image.

### Definition of Terms

In the present disclosure, an image refers to a visual representation as commonly known in the art. The image may be a photograph, a picture, a video frame, for example a frame from a video, or other similar media. An image may be used as input in, for example, a segmentation network, a convolutional neural network (CNN), a hybrid CNN-transformer (ConvFormer), or other similar model for processing the image.

In the present disclosure, processing an image refers to semantic segmentation of an image, and comprises one or more required processes that are performed on the image to generate a segmentation map for the image. The processing may be performed by neural network including CNNs, Transformers, or their hybrid ConvFormers, or other similar model. In an implementation, the processing may be based on a linear attention process, vanilla attention process, a combination thereof (e.g., a hybrid attention process), and/or other similar process.

In the present disclosure, a feature refers to an attribute or variable of an image that may be extracted (e.g., by a feature extractor of a segmentation network) from the image for use in processing the image. In an implementation, it can refer to an intermediate result for a specific operation such convolution, addition, or matrix multiplication.

In the present disclosure, a first matrix (also referred to herein as a left matrix, K matrix or key matrix) refers to a key (also referred to herein as “K” or “K^{T}” (transposed K)) matrix that is an intermediate result in a model (e.g., using an image as input in the model) that is obtained by linear projection of, for example, other intermediate results, features, or matrices in the model. It captures the spatial and contextual information associated with the feature, allowing a model to identify the most important regions for processing the image. For example, a self-attention mechanism in a model operates on three fundamental components: Queries (Q), Keys (K), and Values (V). A query is a representation of an element (or token) that a model is currently focusing on. It may be considered as the model's way of asking how relevant is an element in the context of an entire sequence. For each element in a sequence, the model generates a query vector or matrix, which is then used to evaluate its relationship with other elements in the sequence. Further, keys represent all the elements in the sequence, including the element currently being focused on. Each element in the sequence has a corresponding key vector (e.g., first matrix). These keys serve as reference points that the query vector is compared against. In essence, the key vectors help the model determine how closely related each element in the sequence is to the element currently under focus. In an implementation, the first matrix may be generated by an attention processing unit (e.g., a hybrid attention processing unit or other similar unit) for use in processing the image.

In the present disclosure, a second matrix (also referred to herein as a right matrix, V matrix or value matrix) refers to a value (also referred to herein as “V”) matrix that is an intermediate result in a model (e.g., using an image as input in the model) that is obtained by linear projection of, for example, other intermediate results, features, or matrices in the model. For example, values are what the model uses to construct its understanding of a sequence. Each element in the sequence is associated with a value vector (e.g., second matrix), which holds the contextual information or the “meaning” of the element. Once the model has determined how much attention to give to each element (based on the comparison between the queries and keys), it uses the value vectors to build a weighted representation of the context. In an implementation, the second matrix may be generated by an attention processing unit (e.g., a hybrid attention processing unit or other similar unit) for use in processing the image.

In the present disclosure, information associated with a feature refers to a label, classification, group, type of other similar information (e.g., contextual information or the “meaning”) associated with the feature. This information may be extracted from the image by a model or system as disclosed herein for generating the second matrix.

In the present disclosure, a vanilla attention process refers to an attention mechanism in which attention scores are computed between each pair of tokens in an input sequence associated with an input image, and a resulting weighted sum is used to generate context-aware representations, allowing a model to selectively focus on relevant parts of the input sequence, and enabling it to capture long-range dependencies efficiently. The attention scores are computed using a compatibility function, typically a dot product or a scaled dot product, followed by a softmax operation to obtain a probability distribution over the input tokens.

In the present disclosure, a linear attention process refers to a type of processing on an image (e.g., processing a feature map of an input image) based on a technique that modifies the standard attention mechanism (e.g., vanilla attention process) as used in the state of the art, typically used in transformers, to reduce computational complexity while still capturing global dependencies between pixels of an image, and maintaining sensitivity to local information. It achieves this by approximating the traditional softmax-based attention using carefully designed mapping functions, transforming the complexity, for example, from O(N²) to O(N). It replaces the quadratic complexity of dot-product attention with a linear complexity, making it suitable for high-resolution images and long sequences.

In the present disclosure, a left matrix buffer (LMB) and right matrix buffer (RMB) refers to a component of the hybrid attention process unit that is used for storing and buffering data relating to the first and/or second matrices for processing an image. In an implementation, the LMB and RMB may be utilized for a vanilla attention process and/or a linear attention process depending on how the processing is applied on the image.

In the present disclosure, a LMB-RMB router (also referred to herein as a router) refers to a component of the hybrid attention process unit that is used for transferring data relating to the first and/or second matrices between the LMB and RMB, depending on whether a vanilla attention process and/or a linear attention process is utilized for processing the image.

In the present disclosure, routing the first and/or second matrices refers to a transfer of data relating to the first and/or second matrices through the router from the LMB to the RMB (or vice versa), depending on whether a vanilla attention process and/or a linear attention process is used for processing the image.

In the present disclosure, a LMB overflow refers to a buffer overloading in the LMB that may result from excess external memory access (EMA) typically associated with a vanilla attention process (e.g., caused by a vanilla attention's QK\hat{ }T operation's intermediate feature map). Further, a RMB overflow refers to a buffer overloading in the RMB that may be caused by both K and V matrix and convolution's weight. For example, if all the K, V, and convolutional weights are buffered in the RMB but the RMB does not have sufficient space, then the overflow occurs.

In the present disclosure, determining whether there is a LMB overflow refers to a check based on a vanilla attention (VA) tile size whether there is a LMB overflow or a potential LMB overflow. The check may be performed by an attention tiling manager or similar module configured for performing the check.

In the present disclosure, dividing the vanilla attention process refers to a breaking down of the process into a plurality of smaller portions (e.g., a plurality of smaller processes) such that smaller portions may be processed sequentially and then combined together to reduce EMA. This division may be performed in response to a determination or detection whether there is a LMB overflow or a potential LMB overflow. In an implementation, the breaking down of the vanilla attention process may be by way of dividing each Query (Q) tile associated with the vanilla attention process into a plurality of smaller segments for sequential processing and then combined together.

In the present disclosure, a tile refers to a smaller, discrete region of a feature map, often a square, used to process and analyze large images. A linear attention tile thus refers to a tile which is processed via a linear attention process, while a vanilla attention tile refers to a tile which is processed via a vanilla attention process. As a result of the vanilla and/or linear attention process, one or more tiles may be generated for further processing in order to generate a segmentation map for the image.

In the present disclosure, a fused convolution refers to a combination or fusion of one or more tiles, and/or a process of combining (e.g., fusing) one or more tiles back together (e.g., after dividing a vanilla and/or linear attention process). A fused convolution may be generated via the fusion of the one or more tiles as mentioned above by, for example, a layer-fusion scheduler (LFS) or other similar module configured for performing the generation and/or fusion. By dividing convolutional operations associated with the vanilla and/or linear attention process into smaller, independent tiles and fusing them, computations can advantageously be performed more efficiently, leading to faster processing and potentially lower power consumption. It is appreciated that “first fused convolution” and “second fused convolution” are construed accordingly.

In the present disclosure, processing one or more tiles (e.g., one or more vanilla attention tiles, or one or more linear attention tiles according to implementation) for generating a fused convolution may be performed, in an example, in parallel (e.g., processing all of the one or more tiles simultaneously together at the same time) based on the first matrix (e.g., K or K^{T}) and second matrix (e.g., V), or in other similar manner.

In the present disclosure, scheduling each of the one or more vanilla attention tiles refers to arranging the one or more vanilla attention tiles to be sequentially processed for a fused convolution. The scheduling may be performed by a LFS, a KV-reused vanilla attention-convolution fuser (VACF) of the LFS, or other similar module configured to perform the scheduling. The scheduling may be based on a weight associated with the fused convolution. In an implementation, a fused convolution weight (also referred to herein as a convolution weight) may be utilized to replace the first matrix and second matrix for processing the one or more vanilla attention tiles For example, after replacing the KV matrix, the convolution weight will replace them with the fused convolution which can avoid frequent data fetching between the KV and convolution weight.

In the present disclosure, breaking down a fused convolution refers to separating the fused convolution into a plurality of smaller parts (e.g., into a a plurality of fused convolutions that are non-overlapped) to enable subsequent fusing with one or more boundary tiles residing between linear attention tiles and vanilla attention tiles. In an implementation, zero-padding may be applied on the one or more boundary tiles for fusing with the plurality of non-overlapped fused convolutions.

In the present disclosure, decomposing a convolution weight refers to separating the convolution weight into, for example, two cascaded weights for processing an image. In an implementation, the convolution weight may be separated into two cascaded weights e.g., W₀ and W₁, which may be performed by a cascaded feature map pruner or other similar module.

In the present disclosure, a feature map (Fmap) represents a matrix of values that highlights a presence and location of specific features learned by a network (e.g., a CNN, a hybrid ConvFormer, or other similar model). A Fmap may be generated by convolutional layers (e.g., fused convolutions) as they process input data such as an image. A feature map represents all the intermediate results in the neural network, and may be processed based on the two cascaded weights. In an implementation, redundancy may be injected into the feature map (e.g., by introducing zero bits into the feature map) to enlarge the Fmap. Further, the Fmap may also be processed by a pretrained tiled mask.

In the present disclosure, decoding the pre-trained tiled mask may be performed by a cascaded feature map pruner for separating the mask into a plurality of smaller parts. These plurality of parts may then be utilized for pipeline processing, (e.g., division of a complex task into smaller, more manageable stages or steps so as to improve the timing performance) in which a position associated with each of one or more non-zero bits may be determined. In an implementation, the position associated with each of the one or more non-zero bits may be extracted by flattening each of the plurality of parts. Non-zero bits means the data in the feature map should be proceeded which is determined via training. A training dataset is used to calibrate the importance for each tile based on sorting, for example, suppose we have a matrix of size 100×100, and the tile size is 10×10, then we will have a 10×10 tile, then we transform each tile into 1 data by accumulating its 10×10 data. After accumulation, we will have 10×10=100 tile score, and then a top-k sorting may be performed on these 100 tile scores. If we want to attain 70% sparsity, then we will keep the top-30% score to be non-zero and set the position associated with these non-zero data in the tile-mask to be 1 and the rest 70% to be 0. Thus, we can decode the position of non-zero tile according to the position of non-zero bits in the mask.

### DETAILED DESCRIPTION

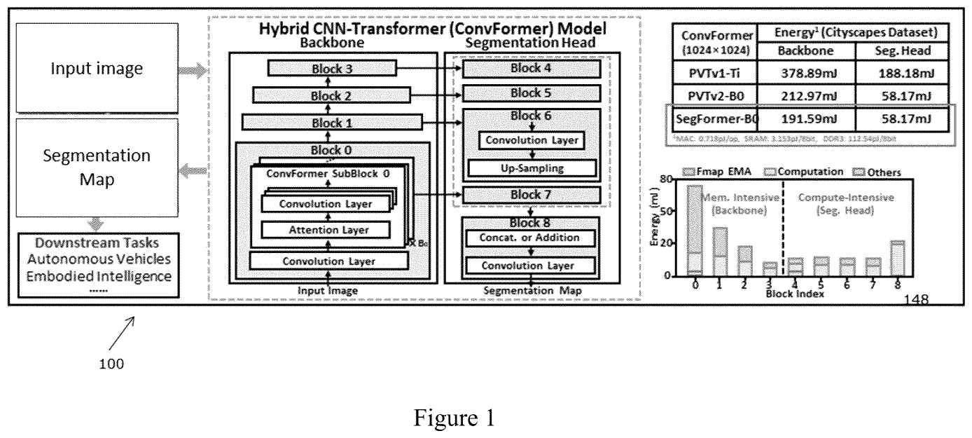

As mentioned above, hybrid models integrating CNN and transformer (ConvFormer) shown for example in illustration 100 of FIG. 1 have achieved significant advancements in semantic segmentation tasks which are critical for autonomous driving and embodied intelligence. CNN enhances the multi-scale feature extraction ability of the transformer to achieve pixel-level classification, but large token length (TL) demand of semantic segmentation (>16K TL) incurs significant computation and memory overheads.

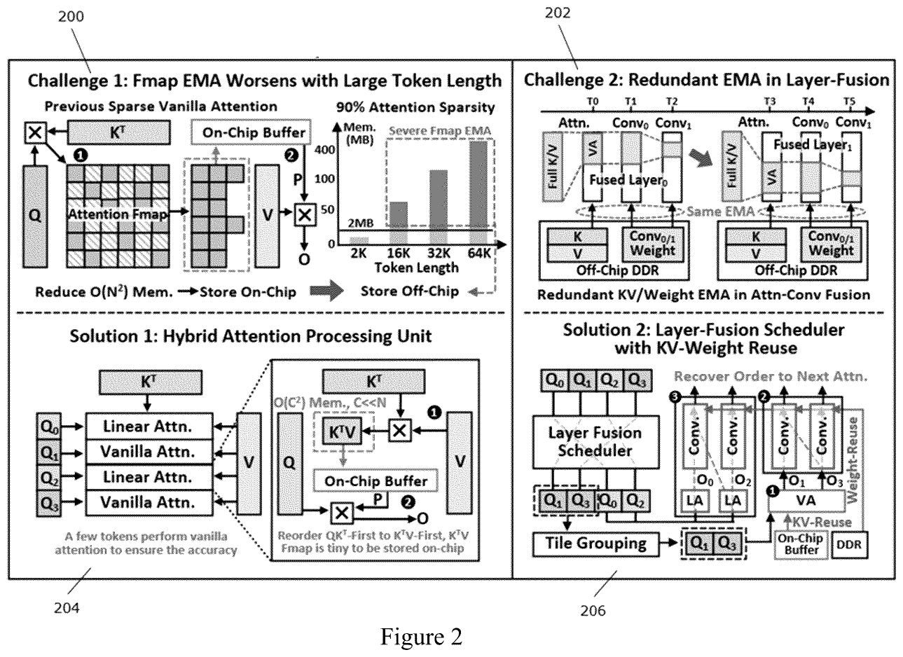

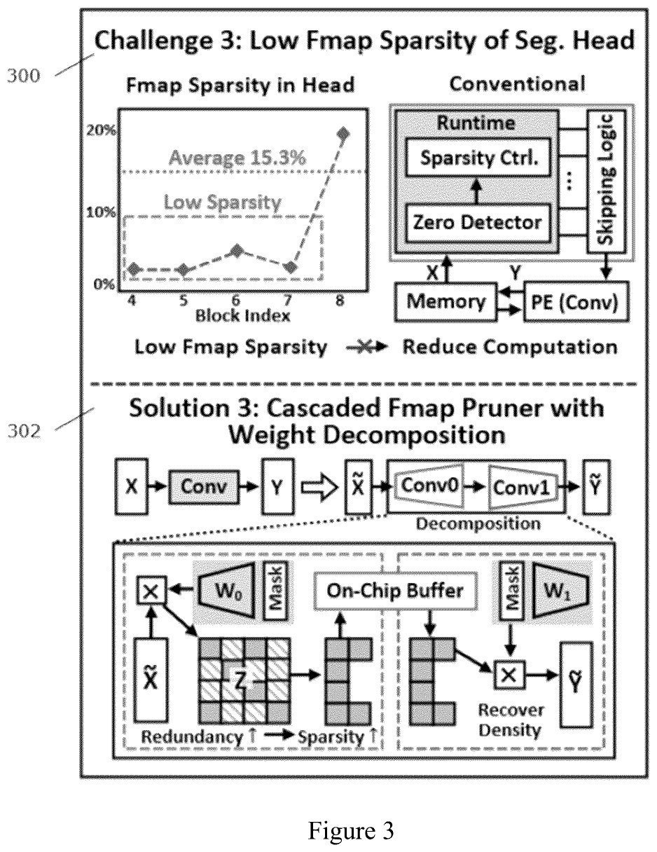

Prior NN accelerators have demonstrated that sparse computing and pruning can effectively reduce computation and weight storage, but most of them focus on pure CNN or Transformer models in simpler vision or language processing tasks (1-4K TL). Moreover, the performance bottlenecks of ConvFormers stem from their memory-intensive Backbone and compute-intensive Segmentation Head (Seg. Head), raising three challenges for hardware acceleration. In a first issue as shown in illustration 200 of FIG. 2, conventional sparse attention fails to buffer attention feature map (Fmap) on-chip when the TL exceeds 16K, even at 90% sparsity, resulting in massive external memory access (EMA). In a second issue as shown in illustration 202 of FIG. 2, while Layer-Fusion (LF) is a common technique to reduce Fmap EMA, it is infeasible to buffer key (K), value (V), and convolution weight on-chip simultaneously. Moreover, different fused attention-convolution layers may cover various vanilla attention (VA) tiles, leading to enormous redundant KV and weight EMA. In a third issue as shown in illustration 300 of FIG. 3, in the Seg. Head, the Fmap sparsity is extremely low, thereby limiting the effectiveness of conventional zero-skipping strategies designed to reduce computations.

To tackle these challenges, a ConvFormer accelerator is proposed with three key features. Firstly, as shown in illustration 204 of FIG. 2, a Hybrid Attention Processing Unit (HAPU) is proposed that utilizes memory-efficient linear attention (LA) for most query (Q) tiles in the Backbone, advantageously reducing Fmap storage from O(N²) to O(C²) by reordering the computation from QK^{T}-first to K^{T}V-first (e.g., K being a first matrix and V being a second matrix for processing an image). Here, N is the TL and C is the channel dimension with C<<N. This reordering allows the HAPU to buffer tiny K^{T}V Fmaps entirely on-chip, advantageously saving 60.2-78.6% EMA. Secondly, as shown in illustration 206 of FIG. 2, an LF Scheduler (LFS) is developed with KV-weight reuse to mitigate redundant EMA overheads of LF in the Backbone. The LFS first reuses on-chip buffered KV to compute all VA tiles, and then replaces the KV with off-chip convolution weights. Afterward, convolution layers are sequentially fused with each VA output tile and LA input tile, reusing both K^{T}V and convolution weights. This approach significantly alleviates redundant EMA, advantageously reducing overall EMA by 86.8-96.2%. Thirdly, as shown in illustration 302 of FIG. 3, a Cascaded Fmap Pruner (CFMP) is designed to decompose each convolution of Seg. Head into two sub-convolutions: a first sub-convolution injects redundancy by expanding the intermediate Fmap, which is further pruned using a pre-trained mask, while the second sub-convolution restores density using the same mask, advantageously reducing 91.10% computation in the Seg. Head.

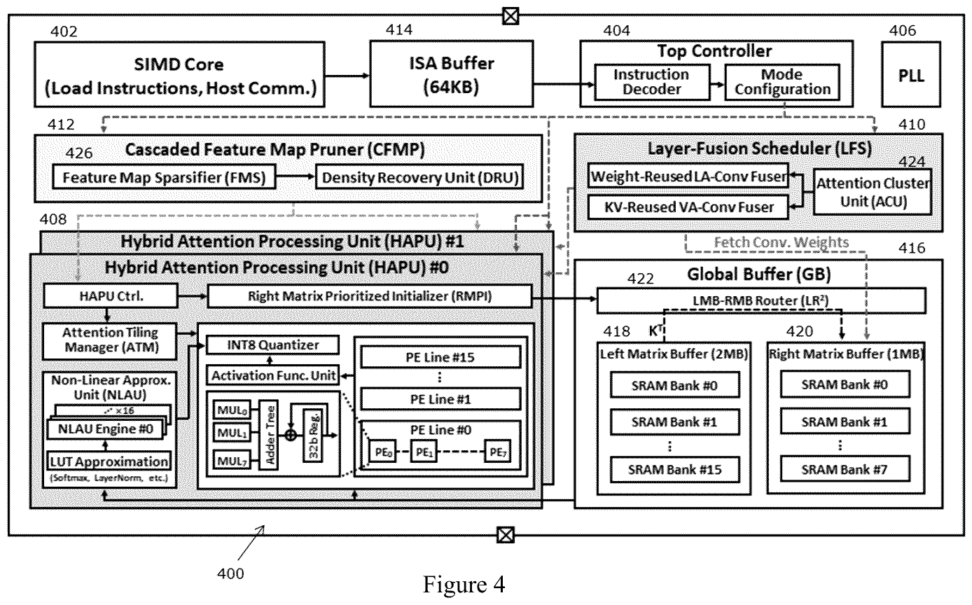

Illustration 400 of FIG. 4 shows an overall architecture of the proposed ConvFormer accelerator. It consists of a single instruction multiple data (SIMD) core 402, a top controller 404, a phase lock loop (PLL) 406, 2 HAPUs 408, a LFS 410, a CFMP 412, a 64 kilobyte (KB) Instruction Set Architecture (ISA) buffer 414, a global buffer (GB) 416 including a 2 megabyte (MB) left matrix buffer (LMB) 418, a 1 MB right matrix buffer (RMB) 420 and an LMB-RMB Router (LR²) 422. In the Backbone stage, the HAPUs 408 prioritize K^{T}, V, and K^{T}V generation, where K^{T} is further routed from LMB 418 to RMB 420 via LR² 422. Then, LFS 410 clusters the VA and LA tiles in a attention cluster unit (ACU) 424, scheduling HAPUs 408 to reuse KV for parallel VA tile processing. Once completed, the LFS 410 replaces the KV with subsequent convolution weights, directing the HAPUs 408 to perform fused convolution on each VA output tile. Then, the remaining convolution layers may reuse these weights to fuse with their associated LA input tiles. In the Seg. Head stage, the top controller 404 configures CFMP 412 using pre-trained sparsity masks. The feature map sparsifier (FMS) 426 decodes the RMB IDs of unpruned column tiles, which are sent to the HAPUs 408 for sparse convolution. Then, a density recovery unit (DRU) 428 of the CFMP 412 converts column tile IDs in FMS 426 to row tile IDs, guiding the HAPUs 408 to recover the density of sparse Fmap via row-wise accumulation.

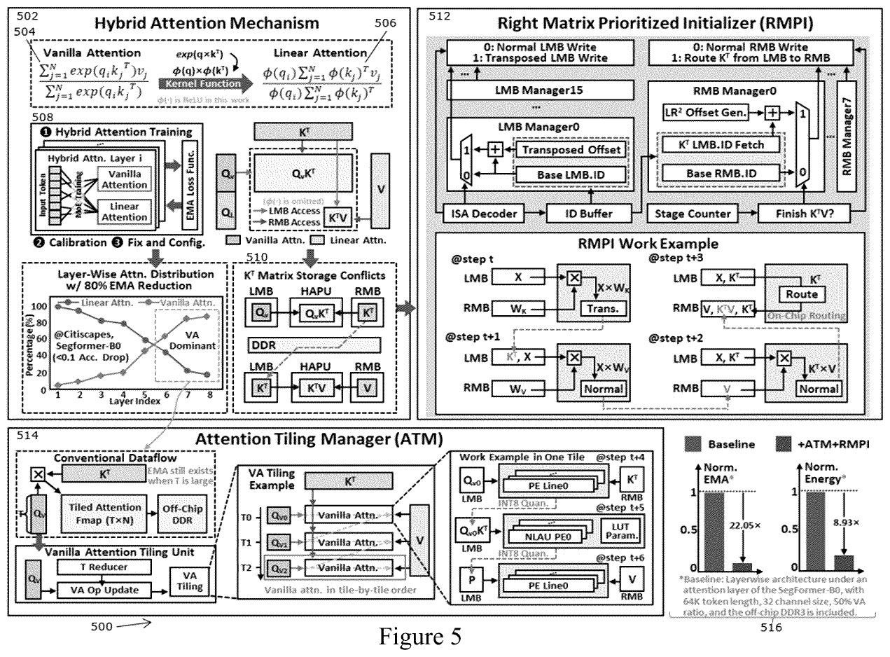

Illustration 500 of FIG. 5 illustrates a HAPU that leverages a hybrid attention mechanism 502 for EMA reduction. This hybrid attention allows most Q tiles to employ LA (as shown in LA function 506), replacing the exponential function of VA (as shown in VA function 504) with separable kernel functions such as identity, rectified linear unit (ReLu), and other similar kernel functions. The hybridization pattern may be learned during training (see hybrid attention training phase 508) and exhibits a layerwise distribution.

However, as the K^{T} serves as a right matrix for QK^{T} in VA and a left matrix for K^{T}V in LA, it incurs storage conflicts (see K^{T} matrix storage conflicts illustration 510) that require K^{T} transfers through double data rate (DDR). To address this issue, a right matrix prioritized initializer (RMPI) 512 may be configured to first compute K^{T}, V, and K^{T}V, and then decode the LR² offset (e.g., decoding an offset associated with the LMB-RMB router) to route K^{T} from LMB to RMB on-chip via LR² (e.g., routing the first and second matrices from the LMB to the RMB via the router based on the offset, the LMB being utilized for a VA process and the RMB being utilized for a LA process).

Further, certain layers may retain a high proportion of VA, leading to large VA tiles that could still cause EMA issues. To mitigate this, an Attention Tiling Manager (ATM) 514 may be configured to identify the VA tile size and speculate potential LMB overflows (e.g., determine whether there is a LMB overflow associated with a VA process). If overflows are detected, the ATM may subdivide each Q tile into smaller segments (e.g., dividing the VA process into a plurality of smaller processes based on the determination), which are processed sequentially and combined together. Compared to layerwise architecture, the HAPU advantageously achieves a reduction in EMA and energy consumption by 22.05× and 8.93×, respectively, for an attention layer with a 64K TL and a 32 channel dimension (as shown in exemplary graphs 516).

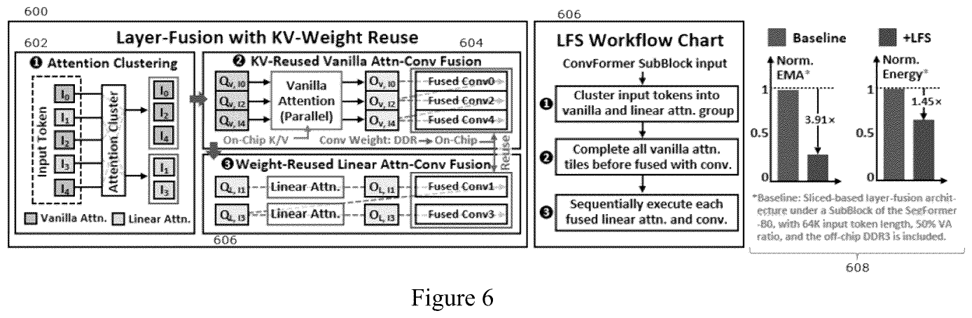

FIG. 6 shows an overview 600 of a layer-fusion with KV-weight reuse process, comprising an attention clustering phase 602, a KV-reused vanilla attention-convolution fusion phase 604, and a weight-reused linear attention-convolution fusion phase 608. For example, as shown in workchart 610, input tokens (e.g., generated from an input image) are clustered into VA and LA groups, all VA tiles are completed before fusing with a corresponding convolution, and then each fused LA and convolution is sequentially executed. Input token is an input of each attention block in the neural network, and VA group is a vanilla attention group that contains the token tiles that will be performed vanilla attention while LA means the linear attention. Convolution is a convolutional operation that will be executed after the attention. Fused LA and convolution means we will not perform the complete linear attention and convolution, but perform their sub-layer and fuse them into one operation..

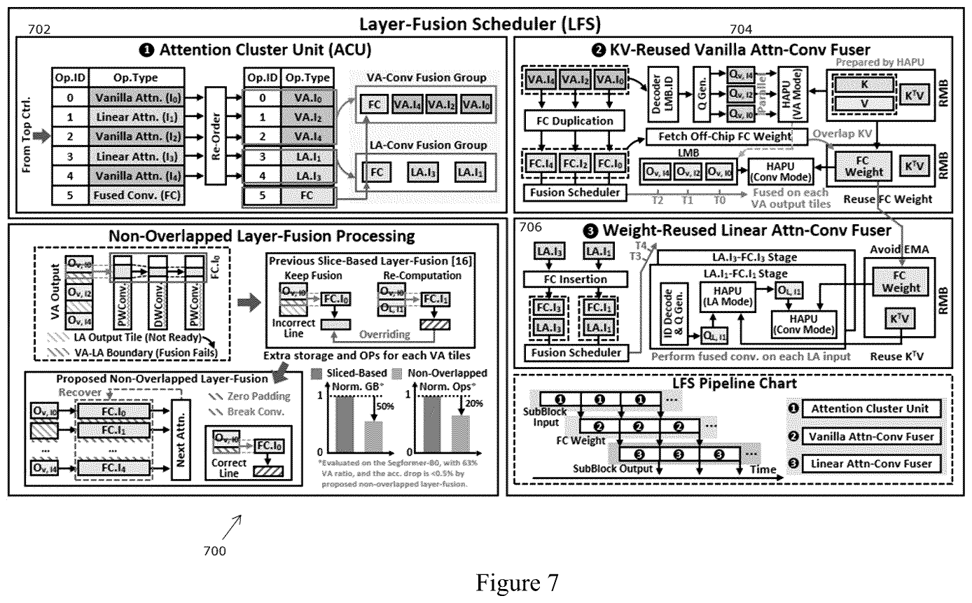

FIG. 7 depicts an exemplary LFS 700 that consists of an ACU 702, a KV-reused vanilla attention-convolution fuser (VACF) 704, and a weight-reused linear attention-convolution fuser (LACF) 706. Owing to a significant reduction in VA proportion by HAPU (e.g., as shown in the exemplary illustration 500 of FIG. 5), all VA tiles can be computed in parallel for most layers. The ACU 702 may initially re-order the VA and LA tiles into two fusion groups, integrating them with a same fused convolution (FC). Subsequently, the VACF 704 decodes the LMB ID for each VA tile to generate Q and reuses the KV prepared by RMPI (e.g., RMPI 512) for parallel VA execution. The VACF 704 may then fetch off-chip FC weights to replace KV, and sequentially schedule each VA output tile for its corresponding FC.

Since the K^{T}V is prepared in advance by RMPI and remains on-chip due to its small size, and the FC weights are already buffed on-chip by VACF 704, the LACF 706 can seamlessly reuse them to perform LF from each LA input tile. However, the convolution cannot fuse with boundary tiles between VA and LA in VACF 704 because the LA output tiles are not yet ready. While slice-based LF methods of the state of the art can handle this with overriding, it incurs extra storage and computation overheads for each VA tile. To address this, a non-overlapped LF processing scheme is proposed in which the FC is broken into several non-overlapped FCs. The subsequent attention layer recovers the broken receptive field by its inherent long-range dependency. The boundary fusion issue is then resolved by zero-padding the unavailable boundary tiles, advantageously resulting in 50% GB usage and 20% operation reduction, with <0.5% accuracy drop. Further, EMA and energy consumption are reduced by 3.91× and 1.45× for a ConvFormer sub-block with a 64K TL and 50% VA ratio (as shown in exemplary graphs 608).

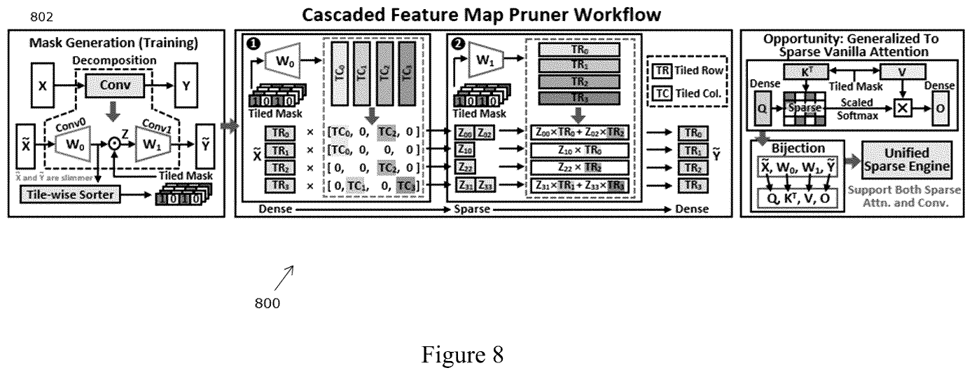

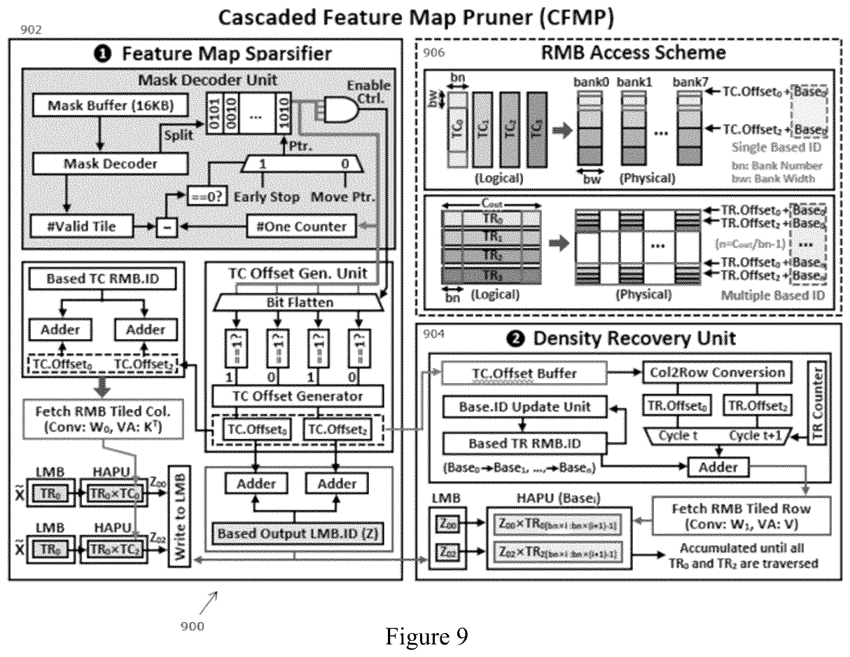

Illustration 800 of FIG. 8 introduces the workflow and architecture of CFMP (as shown in CFMP 900 in FIG. 9), which contains an FMS 902 and a DRU 904. As shown in mask generation training phase 802, the CFMP 900 may be configured to decompose a convolution weight into two cascaded components W₀ and W₁, injecting redundancy by enlarging an intermediate Fmap Z, which is then pruned using pre-trained tiled masks (see also pruning phase 804). Since Z is the only sparse Fmap, with the input and output Fmaps remaining dense, CFMP 900 can be generalized to support sparse VA by substituting the input Fmap, W₀, W₁, and output Fmap in convolution with Q, K^{T}, V, and output Fmap in VA. The FMS 902 begins by decoding the mask and splitting it into multiple parts for pipeline processing (e.g., decoding the pre-trained tiled mask (e.g., a binary tiled mask) into a plurality of parts). Tiled column (TC) offsets are generated by flattening each part (e.g., a process that transform the binary tiled mask into offsets and it will be added with base IDs) and extracting the positions of non-zero bits (e.g., determining a position associated with each of one or more non-zero bits from the plurality of parts). In an implementation, the first matrix may decode a non-zero tiled column based on the binary tiled mask while the second matrix decodes a non-zero tiled row based on the same tiled mask. Once all valid indices are decoded, the FMS halts the current mask decoding and fetches the next one, allowing for an early stop. For example, the decoding process may be disabled by sending a signal to the FMS, which can reduce the latency since we do not need to tranverse all the mask once all the parts are decoded. The TC offsets are combined with the base IDs from the LMB/RMB and sent to the HAPU, where the unpruned TCs are fetched, and the sparse Z is stored in a dense format. Then, the DRU need to obtain unpruned Tiled Rows (TRs) corresponding to each Z tile and its associated mask to recover the Fmap density.

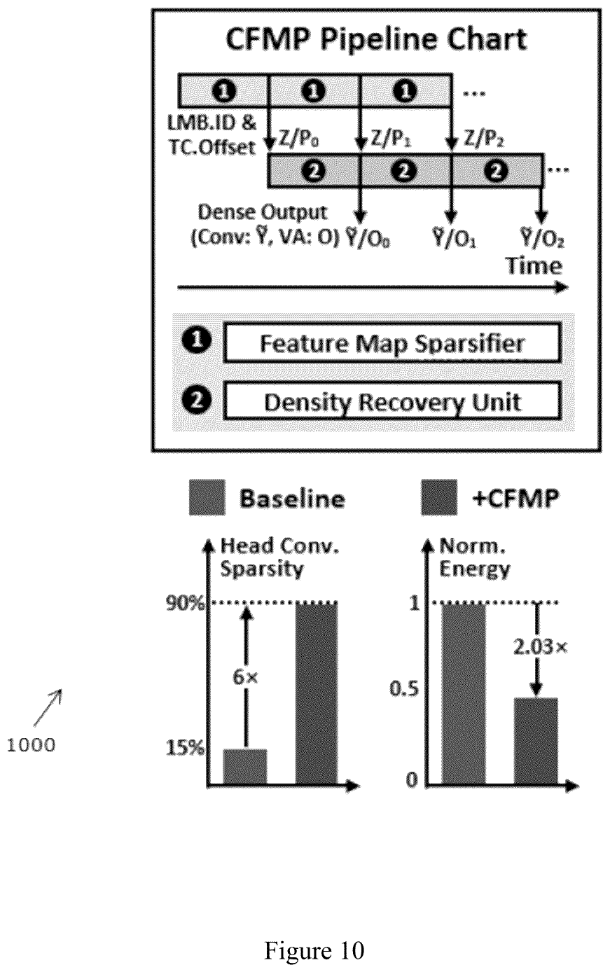

However, as shown in RMB access scheme 906, the physical storage scheme of the RMB maps each TC across different SRAM banks consecutively, resulting in interleaved storage of various TR slices within the same bank from a row-wise perspective. To address this, the DRU 904 may be configured to convert TC offsets into TR form (e.g., via adding a constant value to the TC offsets, and the multiplication results are generated via a multiplier) and recover density by accumulating the multiplication results from different Z tiles and TR slices. Compared to zero-skipping approaches of the state of the art, the CFMP 900 advantageously improves sparsity by 6× in the Seg. Head and reduces energy consumption by 2.03× when pruning both VA and convolution (see illustration 1000 of FIG. 10).

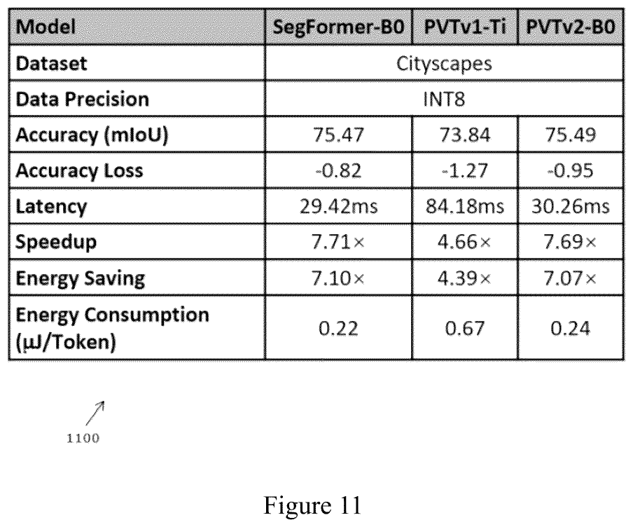

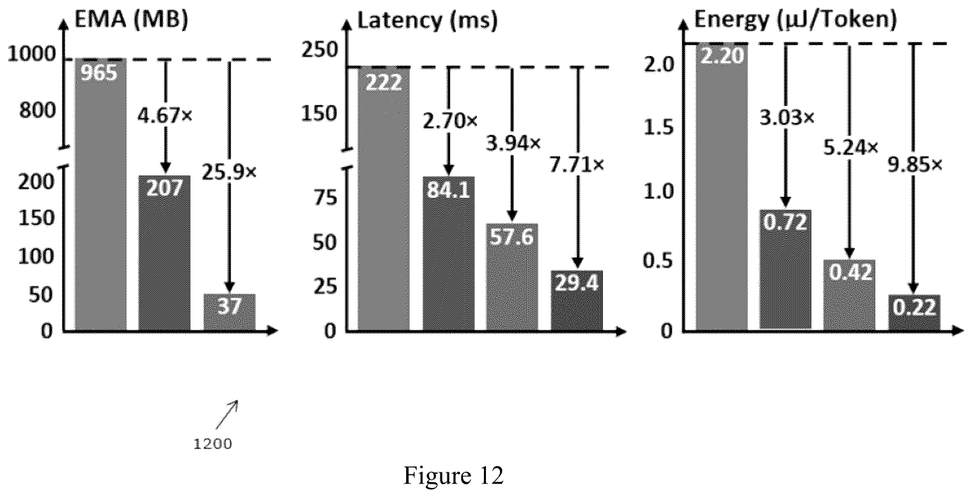

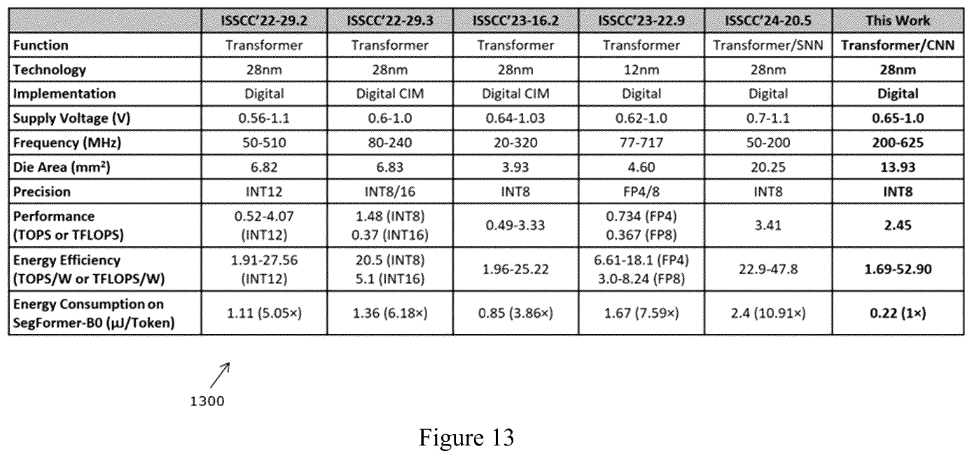

FIGS. 11 to 13 present measurement results for a ConvFormer accelerator fabricated using a 28 nm process. The chip works at 200-625 MHz with a supply voltage of 0.65-1.0V. The peak energy efficiency is 52.90 TOPS/W at 0.65V and 200 MHz. Experiments are conducted on three ConvFormer models, namely SegFormer-B0, PVTv1-Ti, and PVTv2-B0, with a Cityscapes dataset (see table 1100 of FIG. 11). The memory-intensity-aware HAPU and LFS and compute-intensive-aware CFMP advantageously obtained 4.66-7.71× speedup and 4.39-7.10× energy savings compared to the baseline, with negligible accuracy loss. Furthermore, a DDR3 interface is included and it is assumed that all prior state-of-the-art accelerators work at peak energy efficiency with their reported technical configurations, such as pruning ratio, sparse attention patterns, etc., to evaluate system energy consumption for a fair comparison. The results indicate that our chip consumes 0.22 μJ/token for SegFormer-B0, achieving 3.86-10.91× system-level energy reduction. An improvement breakdown analysis on the SegFormer 80 is shown in illustration 1200 of FIG. 12, and a comparison with other state of the art accelerators is shown in table 1300 of FIG. 13.

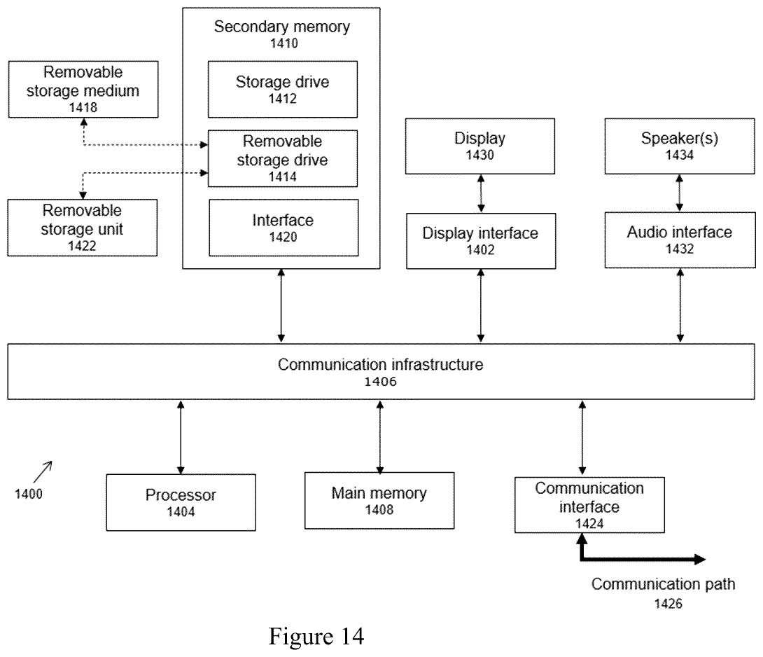

FIG. 14 shows a schematic diagram of an exemplary computing device suitable for use in processing an image.

FIG. 14 depicts an exemplary computing device 1400, hereinafter interchangeably referred to as a computer system 1400, where one or more such computing devices 1400 may be used as a system for processing an image and execute the processes and calculations as depicted in at least FIGS. 2 to 13. The following description of the computing device 1400 is provided by way of example only and is not intended to be limiting.

As shown in FIG. 14, the example computing device 1400 includes a processor 1404 for executing software routines. Although a single processor is shown for the sake of clarity, the computing device 1400 may also include a multi-processor system. The processor 1404 is connected to a communication infrastructure 1406 for communication with other components of the computing device 1400. The communication infrastructure 1406 may include, for example, a communications bus, cross-bar, or network.

The computing device 1400 further includes a main memory 1408, such as a random access memory (RAM), and a secondary memory 1410. The secondary memory 1410 may include, for example, a storage drive 1412, which may be a hard disk drive, a solid state drive or a hybrid drive and/or a removable storage drive 1414, which may include a magnetic tape drive, an optical disk drive, a solid state storage drive (such as a USB flash drive, a flash memory device, a solid state drive or a memory card), or the like. The removable storage drive 1414 reads from and/or writes to a removable storage medium 1418 in a well-known manner. The removable storage medium 1418 may include magnetic tape, optical disk, non-volatile memory storage medium, or the like, which is read by and written to by removable storage drive 1414. As will be appreciated by persons skilled in the relevant art(s), the removable storage medium 1418 includes a computer readable storage medium having stored therein computer executable program code instructions and/or data.

In an alternative implementation, the secondary memory 1410 may additionally or alternatively include other similar means for allowing computer programs or other instructions to be loaded into the computing device 1400. Such means can include, for example, a removable storage unit 1422 and an interface 1420. Examples of a removable storage unit 1422 and interface 1420 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1422 and interfaces 1420 which allow software and data to be transferred from the removable storage unit 1422 to the computer system 1400.

The computing device 1400 also includes at least one communication interface 1424. The communication interface 1424 allows software and data to be transferred between computing device 1400 and external devices via a communication path 1426. In various embodiments of the disclosures, the communication interface 1424 permits data to be transferred between the computing device 1400 and a data communication network, such as a public data or private data communication network. The communication interface 1424 may be used to exchange data between different computing devices 1400 which such computing devices 1400 form part an interconnected computer network. Examples of a communication interface 1424 can include a modem, a network interface (such as an Ethernet card), a communication port (such as a serial, parallel, printer, GPIB, IEEE 1394, RJ45, USB), an antenna with associated circuitry and the like. The communication interface 1424 may be wired or may be wireless. Software and data transferred via the communication interface 1424 are in the form of signals which can be electronic, electromagnetic, optical or other signals capable of being received by communication interface 1424. These signals are provided to the communication interface via the communication path 1426.

As shown in FIG. 14, the computing device 1400 further includes a display interface 1402 which performs operations for rendering images or videos to an associated display 1430 and an audio interface 1432 for performing operations for playing audio content via associated speaker(s) 1434.

As used herein, the term “computer program product” may refer, in part, to removable storage medium 1418, removable storage unit 1422, a hard disk installed in storage drive 1412, or a carrier wave carrying software over communication path 1426 (wireless link or cable) to communication interface 1424. Computer readable storage media refers to any non-transitory, non-volatile tangible storage medium that provides recorded instructions and/or data to the computing device 1400 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1400. Examples of transitory or non-tangible computer readable transmission media that may also participate in the provision of software, application programs, instructions and/or data to the computing device 1400 include radio or infra-red transmission channels as well as a network connection to another computer or networked device, and the Internet or Intranets including e-mail transmissions and information recorded on Websites and the like.

The computer programs (also called computer program code) are stored in main memory 1308 and/or secondary memory 1410. Computer programs can also be received via the communication interface 1424. Such computer programs, when executed, enable the computing device 1400 to perform one or more features of embodiments discussed herein. In various embodiments, the computer programs, when executed, enable the processor 1404 to perform features of the above-described embodiments. Accordingly, such computer programs represent controllers of the computer system 1400.

Software may be stored in a computer program product and loaded into the computing device 1400 using the removable storage drive 1414, the storage drive 1412, or the interface 1420. The computer program product may be a non-transitory computer readable medium. Alternatively, the computer program product may be downloaded to the computer system 1400 over the communications path 1426. The software, when executed by the processor 1404, causes the computing device 1400 to perform, as a system for processing an image, the necessary operations to execute the processes, perform the calculations, and other similar computations as shown in FIGS. 2-13.

It is to be understood that the embodiment of FIG. 14 is presented merely by way of example to explain the operation and structure of a system for processing an image. Therefore, in some embodiments one or more features of the computing device 1400 may be omitted. Also, in some embodiments, one or more features of the computing device 1400 may be combined together. Additionally, in some embodiments, one or more features of the computing device 1400 may be split into one or more component parts.

It will be appreciated by a person skilled in the art that numerous variations and/or modifications may be made to the present disclosure as shown in the specific embodiments without departing from the scope of the disclosure as broadly described. The present embodiments are, therefore, to be considered in all respects to be illustrative and not restrictive.

What is claimed is:

1. A method for processing an image, comprising:
generating, by a hybrid attention processing unit, a first matrix based on a feature associated with the image and a second matrix based on information associated with the feature; and
processing, by the hybrid attention processing unit, the image with the first and second matrices based on a linear attention process.

2. The method of claim 1, wherein processing the image further comprises:
decoding, by the hybrid attention processing unit, an offset associated with a left matrix buffer-right matrix buffer (LMB-RMB) router, and
routing the first and second matrices from a LMB to a RMB via the LMB-RMB router based on the offset, the LMB being utilized for a vanilla attention process and the RMB being utilized for the linear attention process.

3. The method of claim 1, further comprising:
processing the image based on a vanilla attention process for another feature associated with the image;
determining, by an attention tiling manager, whether there is a LMB overflow associated with the vanilla attention process for the another feature; and
dividing the vanilla attention process into a plurality of smaller processes based on the determination.

4. The method of claim 3, further comprising:
generating one or more linear attention tiles from processing the image based on the linear attention process and one or more vanilla attention tiles from processing the image with the vanilla attention process; and
generating, by a layer-fusion scheduler, a first fused convolution based on the one or more linear attention tiles and a second fused convolution based on the one or more vanilla attention tiles.

5. The method of claim 4, further comprising processing, by the layer-fusion scheduler, the one or more vanilla attention tiles in parallel for the second fused convolution based on the first and second matrices.

6. The method of claim 5, further comprising scheduling, by the layer-fusion scheduler, each of the one or more vanilla attention tiles based on a weight associated with the second fused convolution.

7. The method of claim 4, further comprising:
breaking down the first and second fused convolution into a plurality of non-overlapped fused convolutions;
applying zero-padding on one or more boundary tiles residing between the linear attention tiles and the vanilla attention tiles; and
fusing the plurality of non-overlapped fused convolutions with the zero-padded one or more boundary tiles.

8. The method of claim 1, further comprising:
decomposing, by a cascaded feature map pruner, a convolution weight for processing the image into two cascaded weights;
processing a feature map based on the cascaded weights;
injecting redundancy into the feature map; and
further processing the feature map based on a pre-trained tiled mask.

9. The method of claim 1, further comprising:
decoding, by the cascaded feature map pruner, the pre-trained tiled mask into a plurality of parts; and
determining a position associated with each of one or more non-zero bits from the plurality of parts.

10. A system for processing an image, comprising:
a processor; and
a memory storing computer program code,
the memory and the computer program code configured to, with the processor, cause the system to:
generate, by a hybrid attention processing unit, a first matrix based on a feature associated with the image and a second matrix based on information associated with the feature; and
process, by the hybrid attention processing unit, the image with the first and second matrices based on a linear attention process.

11. The system of claim 10, wherein the memory and the computer program code configured to, with the processor, cause the system to process the image by:
decoding, by the hybrid attention processing unit, an offset associated with a left matrix buffer-right matrix buffer (LMB-RMB) router; and
routing the first and second matrices from a LMB to a RMB via the LMB-RMB router based on the offset, the LMB being utilized for a vanilla attention process and the RMB being utilized for the linear attention process.

12. The system of claim 10, further configured to:
process the image based on a vanilla attention process for another feature associated with the image;
determine, by an attention tiling manager, whether there is a LMB overflow associated with the vanilla attention process for the another feature; and
divide the vanilla attention process into a plurality of smaller processes based on the determination.

13. The system of claim 12, further configured to:
generate one or more linear attention tiles from processing the image based on the linear attention process and one or more vanilla attention tiles from processing the image with the vanilla attention process; and
generate, by a layer-fusion scheduler, a first fused convolution based on the one or more linear attention tiles and a second fused convolution based on the one or more vanilla attention tiles.

14. The system of claim 13, further configured to process, by the layer-fusion scheduler, the one or more vanilla attention tiles in parallel for the second fused convolution based on the first and second matrices.

15. The system of claim 14, further configured to schedule, by the layer-fusion scheduler, each of the one or more vanilla attention tiles based on a weight associated with the second fused convolution.

16. The system of claim 13, further configured to:
break down the first and second fused convolution into a plurality of non-overlapped fused convolutions;
apply zero-padding on one or more boundary tiles residing between the linear attention tiles and the vanilla attention tiles; and
fuse the plurality of non-overlapped fused convolutions with the zero-padded one or more boundary tiles.

17. The system of claim 10, further configured to:
decompose, by a cascaded feature map pruner, a convolution weight for processing the image into two cascaded weights;
process a feature map based on the cascaded weights;
inject redundancy into the feature map; and
further process the feature map based on a pre-trained tiled mask.

18. The system of claim 10, further configured to:
decode, by the cascaded feature map pruner, the pre-trained tiled mask into a plurality of parts; and
determine a position associated with each of one or more non-zero bits from the plurality of parts.
